(19) United States
(12) Patent Application Publication
(10) Pub. No.: US 2006/0261008 A1
(43) Pub. Date: Nov. 23, 2006

(54) Activated carbon treatment

(76) Inventors: Piotr Wnukowski, Stockholm (SE); Robert Tigerfalk, Eskilstuna (SE); Alf Thomas Mikael Jonsson, Strangnas (SE)

Correspondence Address: NIXON & VANDERHYE, PC, 901 NORTH GLEBE ROAD, 11TH FLOOR, ARLINGTON, VA, 22203, US

(21) Appl. No.: 10/574,854

(22) PCT Filed: Oct. 7, 2004
(86) PCT No.: PCT/EP04/11387

§ 371 Date: Apr. 6, 2006

(30) Foreign Application Priority Data
Oct. 10, 2003 (EP) 03078201.5

(51) Int. Cl. B01D 61/00

(52) U.S. Cl. 210/650; 210/662; 210/791; 210/636; 435/4; 435/6; 435/253.5; 424/725; 210/767

(57) ABSTRACT

The present invention relates to a process for purification of a compound using an activated carbon treatment. In the process according to the present invention several filter units containing activated carbon immobilized in a matrix are operating in series and in a counter current mode. After passing a suitable volume of feed, a filter unit from the first series of filter units is disconnected at a particular position number, and an additional filter unit is connected at another particular position number herewith obtaining a next series of filter units where over the passing of a next volume of feed is continued. This process overcomes the problem of loss of yield of the purified compound as occurs during conventional activated carbon treatment.

The present invention relates to a process for purification of a compound by using activated carbon treatment.

Since decades, in processes for purifying valuable compounds, activated carbon treatments are applied wherein bulk activated carbon powder is used for removal of impurities such as coloured species from the valuable compound. However, the problem when using bulk carbon powder is that often activated carbon particles migrate down-stream resulting in carbon contamination in subsequent recovery steps. Also, working with bulk carbon in industrial scale purification processes does not benefit health and safety. More recently, activated carbon cartridges have been developed that overcome these problems. In these cartridges, activated carbon is immobilised in a filtration medium. The use of an activated carbon cartridge is described for purification of penicillin V (R. Jansson and M. Weaver, Manufacturing chemist, March 2002, p. 29-30). However, despite the fact that the use of carbon cartridges also removes time consuming recovery processes and leads to an improved quality of the final product, the cartridges have not been widely implemented in industrial processes, despite the long felt need for an improvement of conventional carbon treatment.

One of the problems is that the yield of the desired compound is not always favourable enough to run the purification with activated carbon cartridges at a commercially efficient industrial scale.

The object of the present invention is to overcome this problem of insufficient yield of the desired compound. This problem is solved by the present invention by passing a feed containing the desired compound over a series of filter units containing activated carbon, operating in series and in a counter current mode.

The present invention thus relates to a process for purification of a compound, said process comprising an activated carbon treatment using a filter unit containing activated carbon immobilized in a matrix, the treatment comprising:
a) passing a suitable volume of a feed containing the compound over a first series of n connected filter units operating in series to obtain an effluent, wherein n is at least two, said filter units having been assigned a position number 1 to n in the series and position number 1 being the first supplied with the feed,
b) disconnecting a filter unit from the first series of filter units at any position number between 1 to n−1 after passing the suitable volume of feed, and connecting a fresh filter unit at any position that has a higher number than the position number of the disconnected filter unit, resulting in a next series of filter units,
c) passing a next suitable volume of feed containing the compound over the next series of filter units to obtain a next effluent,
d) optionally combining the effluents obtained in a and c, and
e) recovering the compound from the effluent.

Use of carbon treatment in accordance with the present invention results in increased yield of the purified compound. Also, use of carbon treatment in accordance with the present invention results in a complete or nearly complete utilization of available adsorption capacity of activated carbon. Furthermore, application of the activated carbon treatment according to the present invention provides a high throughput purification system. High throughput implies shorter processing times and improved logistics. This results in increased capacity to produce more valuable compound at an industrial scale. In addition, the yield of the purified compound is increased, especially in processes for purification of an unstable compound.

The carbon treatment according to the invention is applicable to any purification process of a compound of interest wherein a conventional activated carbon treatment is used.

In the present invention, the compound to be purified advantageously may be an unstable compound, i.e. a compound that decomposes and/or degrades as processing and/or storage time increases.

The compound may comprise secondary metabolites or proteins. Secondary metabolites may comprise antibiotics, vitamins, carotenoids or polyunsaturated fatty acids (PUFAs). Proteins may comprise enzymes, such as proteases, amylases, cellulases, xylanases, lactases, or their precursors. Antibiotics may comprise streptomycin, chloramphenicol, actinomycin, tetracycline, natamycin, β-lactam compounds like clavulanic acid, penicillin-G, penicillin-V, cephalosporin C, cephamycin, 6-aminopenicillinic acid (6-APA), 7-aminodeacetoxy cephalosporinic acid (7-ADCA), 7-aminocephalosporanic acid (7-ACA), semisynthetic penicillins such as amoxicillin, cloxacillin, flucloxacillin, methicillin, oxacillin, carbenicillin, ampicillin and semisynthetic cephalosporins such as sephalexin, cephadrin, cephaloridine, cephalothin, cefaclor, cefadroxil. The carotenoids may comprise β-carotene.

In a particular embodiment of the present invention, the compound is produced by fermentation using a micro-organism. The micro-organism may be prokaryotic or eukaryotic or a cell or cell line of mammalian or plant origin that is capable of producing a compound of interest during fermentation. Preferably, the micro-organism is a bacterium, a fungus or a yeast. The bacterium may be an E. coli, Streptomyces, Bacillus or Propionibacterium strain. The fungus may be a Penicillium, Aspergillus or Mucor strain. The yeast may be a Saccharomyces, Kluyveromyces or Pichia strain.

In a preferred embodiment of the present invention, the compound is obtained by fermentation using as micro-organism a Streptomyces species. Compounds obtained by fermentation of Streptomyces species are particularly suitable to be purified using the carbon treatment according to the present invention since a fermentation broth obtained from Streptomyces species, and also the produced compound, contains a coloring species and other impurities that may notably be manifested by a yellow-to-red/brown color. According to the present invention, these coloring species and other impurities are very efficiently removed from the compound with a surprisingly high yield of the purified compound. Preferred Streptomyces species may be Streptomyces clavuligerus, S. coelicolor, S. griseus, S. Venezuela, S. aureofaciens. The compounds produced by these strains may be clavulanic acid, streptomycin, cephamycin, chloramphenicol, tetracycline, actinomycin or β-carotene. Preferably, the compound is clavulanic acid.

The fermentation fluid comprising the compound of interest may be separated from the biomass in the fermentation broth by filtration. Optionally, the fermentation fluid comprising the compound may be concentrated and/or the compound may be precipitated or purified using techniques known in the art, prior to the treatment with activated carbon. The feed that is subjected to the activated carbon treatment according to the present invention contains the compound and includes a solvent. The solvent that is used typically will depend on the compound of interest. It may be water, an alcohol, a ketone, an ester, an ether or a mixture thereof. Preferably, it comprises an ester like an alkylacetate, more preferably ethylacetate or methylacetate.

The filter units contain activated carbon immobilized in a matrix. The matrix may be any porous filter medium permeable for the feed containing the compound. Preferably, the matrix comprises a support material and/or a binder material. The support material in the matrix may be a synthetic polymer or a polymer of natural origin. The synthetic polymer may include polystyrene, polyacrylamide, polymethyl methacrylate. The polymer of natural origin may include cellulose, polysaccharide, dextran, agarose. Preferably the polymer support material is in the form of a fibre network to provide sufficient mechanical rigidity. The binder material may be a resin. The matrix may have the form of a membrane sheet.

Preferably, the activated carbon immobilized in a matrix may be in the form of a cartridge. A cartridge is a self-containing and readily replaceable entity containing powdered activated carbon immobilized in the matrix and prepared in the form of a membrane sheet. The membrane sheet may be captured in a plastic permeable support to form a disc. Alternatively, the membrane sheet may be spirally wound. To increase filter surface area, several discs may be stacked upon each other. Preferably, the discs stacked upon each other have a central core pipe for collecting and removal of the carbon-treated feed from the filter unit. The configuration of stacked discs may be lenticular. It is further possible to add additional cartridges to an existing filter unit, either by putting these additional cartridges on the same collector axis (and by doing so extending the height of the stack) or by accommodating a parallel stack of cartridges in the same filter unit and, optionally, connecting the separate collector axes in one outlet at the bottom of the filter housing.

Carbon may be used from different sources of raw material such as peat, lignite, wood or coconut shell. The choice of carbon source depends on the compound to be isolated and may be determined according to methods known in the art. Any process known in the art, such as steam or chemical treatment, may be used to activate carbon.

In the present invention, the activated carbon immobilized in a matrix may be placed in a housing to form an independent filter unit. Each filter unit has its own in-let and out-let for the feed containing the compound to be purified. Examples of filter units that are usable in the present invention are the carbon cartridges from Cuno Inc. (Meriden, USA) or Pall Corporation (East Hill, USA).

In the process of the invention, after passing a suitable volume of feed a filter unit at any position number between n to n−1 is disconnected from the series of 1 to n connected filters units and a fresh filter unit is connected at any position that has a higher position number than the position number of the disconnected filter unit (filter unit switching). The size of the “suitable volume of feed” (or the moment of filter unit switching) is dependent on various parameters and may be determined by normal process optimalisation. For instance, the feed volume may be dependent on the required quality of the effluent and/or on the amount of filter units used. Thus, filter unit switching may occur at the moment that a used filter unit is substantially saturated with impurities. The moment at which a used filter unit is substantially saturated with impurities may, for instance, be visible by the color of the effluent reaching a value that is not acceptable.

In a preferred embodiment, the feed volume passed over the first series of n connected filter units is of the same size as the next feed volume passed over the next series of filter units. In this way, process logistics are kept as simple and reproducible as possible.

In another preferred embodiment, a filter unit may be disconnected at position number 1 and a fresh filter unit may be connected at position number n+1.

To diminish loss of the compound of interest, the filter unit may be rinsed with solvent before filter unit switching, preferably using the same solvent as wherein the compound is dissolved. The rinsing with solvent may be preceded and/or followed by purging with a gas, preferably nitrogen. In this way residual product adsorbed to the carbon and/or residual product in the feed volume remaining inside the matrix can be recovered.

In the process according to the present invention a feed containing the compound is passed over at least 2 connected filter units operating in series, i.e. n is at least 2. Preferably n is 2 to 10. More preferably, n is 2 to 4, most preferably n is 3. Also, several filter units operating in series may additionally be connected in parallel in order to process large streams of feed comprising the compound to be purified.

In one particular embodiment of the invention, wherein a series of 2 connected filter units is used, the filter unit in position number one, i.e. at the head of the series, is supplied with a feed containing the compound to be purified and the effluent of this filter unit one is passed over a second filter unit in position number 2. When a suitable volume of feed has passed through the filter units, a switch in use of the filter units is made by disconnecting the filter unit in position number 1 and connecting a fresh filter unit in position number 3, resulting in a renumbering of the position numbers since the filter unit original at position number 2 is now first supplied with feed and assigned position number 1 and the filter unit previously in position number 3 is now assigned position number 2.

In another embodiment of the invention, when a series of 3 connected filter units is used, the filter unit in position number one, i.e. at the head of the series, is supplied with the feed containing the compound to be purified and the effluent of this filter unit one is passed over a second filter unit in position number 2 and the effluent of this filter unit two is passed over a third filter unit in position number 3. When a suitable volume of feed has passed through the three filter units, a switch in use of the filter units is made by disconnecting the filter unit in position number 1 and connecting a fresh filter unit in position number 4 resulting in a subsequent renumbering of the position numbers since the filter unit original at position number 2 is now first supplied with feed and assigned position number 1 and the filter unit previously in position number 3 is now assigned position number 2 and the fresh filter unit connected at position number 4 is now assigned position number 3. Alternatively, instead of disconnection of the first filter unit, the second one (i.e. in position number 2) may be disconnected, resulting in that the filter unit in position number 1 remains here since it is still first supplied with feed and the filter unit in position number 3 is now assigned position number 2 and the fresh filter unit connected at position number 4 is assigned position number 3 in the second series.

The filter unit disconnected from the series is a filter unit that contains used activated carbon, i.e. feed containing the compound to be purified has been passed over this activated carbon. The fresh filter unit that is connected to the series is a filter unit that may contain un-used activated carbon (i.e. activated carbon not used before) or it may contain used before and regenerated activated carbon. The fresh filter unit may be wetted with solvent and subsequently purged with nitrogen prior to its use.

Regenerated activated carbon has been subjected to a regeneration process to recover the adsorption capacity of the activated carbon. Regeneration may be accomplished by rinsing with a solvent according to processes known in the art. Typical solvents for regeneration may be methanol, ethanol, acetone or ethylacetate. Regeneration may occur in situ. With in situ is meant that the filter unit containing the activated carbon that is regenerated is rinsed with a solvent without the need either to physically move the filter unit from its position in the series or to physically move the activated carbon from the filter unit. During regeneration the activated carbon may be subjected to the operations of rinsing with the solvent present in the previous feed, and/or rinsing with the regeneration solvent, and/or wetting with the solvent present in the next feed. In between the operations of rinsing and/or wetting the activated carbon may be purged with a gas, preferably nitrogen.

In the process according to the present invention, each filter unit may be connected and disconnected from the series of filter units by physical movement of the unit. Preferably, the filter unit may be connected and disconnected from the series of filter units without physical movement of the unit. This may be facilitated by a flow distribution system. This flow distribution system may be fully automated. Preferably, the flow distribution system may comprise multi-functional and multi-port valves preferably of the block-and-bleed type. The operation of said valves may be controlled by software. More preferably, connection and disconnection of filter units takes place simultaneously.

In the present invention, the process may be operated in batch, semi-continuous or continuous mode.

With operation in batch mode is meant a process wherein a suitable volume of feed is passed over the connected filter units operating in series and wherein said feed is terminated at the moment a filter unit is disconnected and/or a fresh filter unit is connected to the series. Subsequently, after the disconnection and connection (filter unit switching) has taken place, the flow of feed is continued with a next suitable volume of feed.

With operation in continuous mode is meant a process wherein the feed flow is not interrupted at the moment a filter unit is disconnected and a fresh filter unit is connected, i.e. is not interrupted at the moment of filter unit switching. So a suitable volume of feed and any next suitable volume of feed are continuously passed over the series of n connected filter units, with filter unit switching occurring at suitable time intervals. Operation in continuous mode is preferably done in a situation where it is known which volume of feed can be passed of the series of filter units before filter unit switching has to occur. This knowledge can be obtained by experience or by, for instance, in-line measurement. A prerequisite of performance in continuous mode is that the time needed for the operation of filter unit switching should be shorter than the time needed to substantially saturate a filter unit with impurities. A continuous process may be ended, for instance, when a change to a new (batch) protocol is desired or for reasons of cleaning or maintenance.

With operation in semi-continuous mode is meant a process wherein the feed is not interrupted at the moment a filter unit is disconnected and a fresh filter unit is connected, i.e. is not interrupted at the moment of filter switching, but wherein the feed is interrupted to prevent substantial saturation of a filter unit with impurities. The latter may happen when the time needed for the filter unit switching operation is longer than the time needed to substantially saturate a filter unit with impurities.

The process according to the present invention can be carried out in a variety of embodiments, all aiming to increased yield of the compound.

In a first embodiment, the flow rate of the feed is 0.05 to 400 L/min, preferably 20 to 100 L/min, more preferably 30 to 40 L/min. The flow rate of the feed is at least 0.05 L/min. Preferably the flow rate is at least 20 L/min, more preferably the flow rate is at least 30 L/min. The flow rate may have a maximum of 400 L/min. Preferably the flow rate is not above 100 L/min, more preferably, the flow rate is not above 40 L/min.

In yet another embodiment, when the activated carbon immobilized in a matrix is in the form of a membrane sheet with surface area given in square meters (m²), the flux of the feed is 1 to 50 L/m²/min., preferably 1.5 to 20 L/m²/min., more preferably 1.5 to 10 L/m²/min. Preferably, the flux is at least 1 L/m²/min. More preferably, the flux is at least 1.5 L/m²/min. The flux may have a maximum of 50 L/m²/min, preferably the flux is not above 20 L/m²/min, more preferably the flux is not above 15 L/m²/min. With flux is meant the flow rate of the feed per square metre of the surface area of the membrane sheet.

In yet another embodiment, the residence time of the feed containing the compound in a single filter unit is at least 15 seconds and maximal 60 minutes. The residence time of the feed containing the compound in a single filter unit is at least 15 s, preferably it is at least 30 s, more preferably it is at least 60 s, most preferably it is 2 min. The residence time of the compound in a single filter unit is maximal 60 min, preferably it is not more than 30 min, more preferably it is not more than 15 min. The residence time of the feed containing the compound in a single filter unit can be determined by measuring the difference in time between feedᵢₙ and feedₒᵤₜ over a single filter unit. When a feed containing the compound is passed over n connected filter units in series, the total residence time of the feed in the series is n times the residence time in a single filter unit.

In yet another embodiment, the process may be operated at a temperature between minus 10 to +40° C. It may be clear that the temperature is chosen in a way that the feed containing the compound is in the liquid phase both before and after passing it over the filter units. The temperature may be dependent on the type of solvent present in the feed, and the thermo-stability of the compound. The temperature is at least minus 10° C., preferably it is at least minus 2° C., more preferable it is at least 5° C. The temperature may be not more than 40° C., preferably it is not more than 25° C., more preferably it is not more than 15° C.

After applying the activated carbon treatment according to the present invention, the compound is recovered from the effluent according to processes known to a person skilled in the art. The processes that are used for recovery typically will depend on the type of compound and/or on the intended use. Recovery may include one or a combination of at least two of: stabilising the compound in the effluent with suitable stabilising agents, concentrating the effluent, drying the effluent, subjecting the effluent to a granulation process, purifying the compound out of the effluent by e.g. crystallisation and/or column chromatography.

The recovered compound may be further converted into a pharmaceutically acceptable salt or a food grade product.

### EXAMPLE 1

An aqueous broth of clavulanic acid obtained by fermentation of Streptomyces clavuligerus was filtered, extracted and concentrated to 30 g/l prior to activated carbon treatment. 500 ml of concentrated extract was added to a beaker containing 50 g of bulk powdered activated carbon and magnetic stirrer. After a reaction time of 90 minutes, activated carbon was separated from the extract by using a Buchner funnel. The percentage decolourisation was determined by measurement of differences in extinction of the extract before and after activated carbon treatment on a calorimeter. Percentage decolourisation was 90%. Yield of clavulanic acid after activated carbon treatment was 86%.

### EXAMPLE 2

A fermentative obtained aqueous broth of clavulanic acid was filtered, extracted and concentrated to 30 g/l prior to activated carbon treatment. 500 ml of the concentrated extract was passed over a single filter unit containing an activated carbon filter plate (Zetacarbon® R35, ø90 mm from CUNO Ltd.) with approximate effective surface area of 0.0057 m². Flow of the feed with concentrated extract over the filter unit was set at 0.03 L/min. Flux was 5.0 L/min/m². Percentage decolourisation was 90%. Yield of clavulanic acid after carbon treatment was 90%.

### EXAMPLE 3

A feed of 37.5 litres containing concentrated clavulanic acid extract (25 g/L) was passed over 3 connected filter units operating in series, each filter unit containing fresh activated carbon cartridges (Zetacarbon® C08DB; R35S from CUNO Ltd.) with approximately 0.29 m² of effective surface area. The flow rate of the feed was 1.0 L/min. and the flux was 3.5 L/min./m². The filter unit in position number 1 was first supplied with feed containing the impure extract. The filter unit in position number 2 was exposed to the effluent from filter unit 1. The filter unit in position number 3 was exposed to the effluent from filter unit 2. A fourth additional filter unit was lined up in the series at position number 4 but not in service since it is not connected to the series of 3 filter units.

After passing the 37.5 litres of extract over the 3 filter units, the filter unit number 1 that was first supplied with feed was disconnected from the series and an additional filter unit previously in position number 4 was connected to the series resulting in new assignment of position numbers: the unit previously in position number 4 is now assigned position number 3; the unit previously in position number 3 is now assigned position number 2; the unit previously in position number 2 is now assigned position number 1, to form a second series of 3 connected filter units operating in series, wherein the first and second one in the series are both once used and the third filter unit in the series is fresh. After disconnecting the filter unit and connecting the fresh one, the feed was continued by passing 37.5 litres of non-carbon treated feed containing concentrated clavulanic acid extract over this second series of 3 connected filter units. In this second filtration the decolourisation percentage was 94%. Total yield of clavulanic acid was 94%.

### EXAMPLE 4

The activated carbon treatment of example 3 was repeated with the following difference: The filter units in both the first and the second series of 3 connected filter units contained respectively a twice used cartridge at position number 1, a once used cartridge at position number 2 and a fresh cartridge at position number 3. In the second filtration the decolourisation percentage was 93%. The yield of clavulanic acid in the total collected decolourised extract was 97%.

### EXAMPLE 5

The activated carbon treatment was carried out according to example 4. After passing the feed with clavulanic acid over the second series of filter units, the activated carbon cartridges contained in the filter units were washed by passing 21 l of ethylacetate over the filter units. The decolourisation percentage was 94%. The yield of the total collected decolourised extract was 98%.

1. Process for purification of a compound comprising an activated carbon treatment using a filter unit containing activated carbon immobilized in a matrix, the treatment comprising:
a) passing a suitable volume of a feed containing the compound over a first series of n connected filter units operating in series to obtain an effluent, wherein n is at least two, said filter units having been assigned a position number 1 to n in the series and position number 1 being the first supplied with the feed,
b) disconnecting a filter unit from the first series of filter units at any position number between 1 to n−1 after passing the suitable volume of feed, and connecting a fresh filter unit at any position that has a higher number than the position number of the disconnected filter unit, resulting in a next series of filter units,
c) passing a next suitable volume of feed containing the compound over the next series of filter units to obtain a next effluent,
d) optionally combining the effluents obtained in a and c, and
e) recovering the compound from the effluent.

2. The process according to claim 1, wherein the filter unit is disconnected at position number between 1 to n−1 and wherein the fresh filter unit is connected at position number n+1.

3. The process according to claim 1, wherein the filter unit is disconnected at position number 1 and wherein the fresh filter unit is connected at position number n+1.

4. The process according to claim 1 wherein the number n of connected filter units operating in series is 2 to 10.

5. The process according to claim 1, wherein the treatment is operated in batch, semi-continuous or continuous mode.

6. The process according to claim 1, wherein the flow rate of the feed is 0.05 to 400 L/min, preferably 20 to 100 L/min, more preferably 30 to 40 L/min.

7. The process according to claim 1 wherein the activated carbon immobilized in a matrix is in the form of a membrane sheet.

8. The process according to claim 7, wherein the flux over the membrane sheet is 1 to 50 L/m2/min., preferably 1.5 to 20 L/m2/min., more preferably 1.5 to 10 L/m2/min.

9. The process according to claim 1, wherein the residence time of the feed containing the compound in a single filter unit is at least 15 seconds and maximal 60 minutes.

10. The process according to claim 1, wherein the process is operated at a temperature between minus ° C. to 40° C.

11. The process according to claim 1, wherein at least one disconnected filter unit is regenerated in situ by rinsing with a solvent.

12. The process according to claim 1, wherein the compound is an unstable compound.

13. The process according to claim 1, wherein the compound is a secondary metabolite or a protein.

14. The process according to claim 13, wherein the secondary metabolite is selected from the group consisting of an antibiotic, a vitamin, a carotenoid or a PUFA.

15. The process according to claim 1, wherein the compound is obtained by fermentation using a microorganism.

16. The process according to claim 14, wherein the microorganism is a Streptomyces species.

17. The process according to claim 15, wherein the Streptomyces species is selected from the group consisting of S. clavuligerus, S. coelicolor, S. griseus, S. Venezuela, S. jumonjinensis, S. katsurahamanus or S. aureofaciens.

18. The process according to claim 14, wherein the compound is selected from the group consisting of clavulanic acid, streptomycin, chloramphenicol, tetracycline or p3-carotene.

19. The process according to claim 1, further comprising the step of converting the compound into a pharmaceutical acceptable salt or food grade product.
